(19) United States
(12) Patent Application Publication
(10) Pub. No.: US 2010/0010713 A1
(43) Pub. Date: Jan. 14, 2010

(54) THRESHING ROTOR POWER MONITOR

(76) Inventors: Alan D. Sheidler, Moline, IL (US); Bradley K. Yanke, Bettendorf, IA (US)

Correspondence Address: Taylor & Aust, P.C/Deere & Company, P.O. Box 560, Avilla, IN, 46710, US

(21) Appl. No.: 12/170,752

(22) Filed: Jul. 10, 2008

(51) Int. Cl. G06F 19/00

(52) U.S. Cl. 701/50

(57) ABSTRACT

A harvesting machine including an engine and a grain threshing system driven by the engine. The grain threshing system includes at least one rotating member, at least one concave, a torque measuring device and an adjustment mechanism. The at least one rotating member receives a torque from the engine. The at least one concave is proximate to the at least one rotating member. The torque measuring device is coupled to the rotating member or the engine. The torque measuring device produces a signal related to the torque applied to the rotating member. The adjusting mechanism is coupled to the at least one concave. The adjusting mechanism is configured to position the at least one concave relative to the at least one rotating member dependent upon the signal.

The present invention relates to a threshing mechanism, and more particularly, to a threshing mechanism in a harvesting vehicle.

### BACKGROUND OF THE INVENTION

A grain harvesting vehicle, also known as a combine, includes a header, which cuts the crop and feeds the crop matter into a threshing rotor. The threshing rotor rotates within a perforated housing, which may be in the form of adjustable concaves and performs a threshing operation of the grain from the crop matter directed thereinto. Once the grain is threshed it falls through perforations in the concaves onto a grain pan. From the grain pan the grain falls through a set of sieves that vibrate and/or oscillate causing the clean grain to fall through the sieves for collection of the grain and the removal of the chaff and/or other debris. A cleaning fan blows air through the sieves to discharge the chaff towards the rear of the combine. Crop residue such as straw from the threshing section proceeds through a straw chopper and out the rear of the combine.

Grain losses, grain damage, fuel consumption and performance of a combine is related to how well the operator has set the various adjustable elements of the combine in order to provide optimal results for the intended crop and crop conditions. One of the elements that require adjustment include the rotor speed and the concave clearance for the threshing rotor. The adjustment that the operator makes offers opportunity for either good or poor results based upon the adjustments. If the rotor speed and concave clearance are set correctly, the grain can be threshed efficiently with little damage, minimal losses and optimal fuel usage. If the rotor/concave clearance is set too tight and the rotor speed is too high for the conditions, severe grain damage may result and excessive threshing power will be utilized, which can lead to lost productivity and poor fuel economy. If the concave is set too wide and the rotor speed is too low, the grain may not be threshed out properly, resulting in excessive losses out the back of the combine.

Currently the setting of the concave clearance and speed of the rotor is accomplished by trial and error, by the running of the combine for a short period of time, such as 30 seconds or a minute with initial “book” settings, then the crop residue is checked behind the combine and also the grain in the grain tank is checked for losses and damage to the grain. If the settings for the rotor speed or the concave clearance is changed then another trial run is repeated. Currently performance and fuel economy are difficult to evaluate except in comparison to other machines and by long term fuel consumption measurements.

What is needed in the art is a cost effective, economical way of determining if the rotor and concave settings are correct for the harvesting conditions.

### SUMMARY OF THE INVENTION

The present invention provides a way to control and the concave settings in a harvesting machine based on torque being applied to the rotor.

The invention in one form is directed to a harvesting machine including an engine and a grain threshing system driven by the engine. The grain threshing system includes at least one rotating member, at least one concave, a torque measuring device and an adjustment mechanism. The at least one rotating member receives a torque from the engine. The at least one concave is proximate to the at least one rotating member. The torque measuring device is coupled to the rotating member or the engine. The torque measuring device produces a signal related to the torque applied to the rotating member. The adjusting mechanism is coupled to the at least one concave. The adjusting mechanism is configured to position the at least one concave relative to the at least one rotating member dependent upon the signal.

### BRIEF DESCRIPTION OF THE DRAWINGS

FIG. 1 is an illustrated vehicle utilizing an embodiment of the grain threshing system of the present invention;

FIG. 2 is a schematical diagram of elements of the grain threshing system of the present invention; and

FIG. 3 is a flow chart illustrating steps of an embodiment of a method of the present invention.

### DETAILED DESCRIPTION OF THE INVENTION

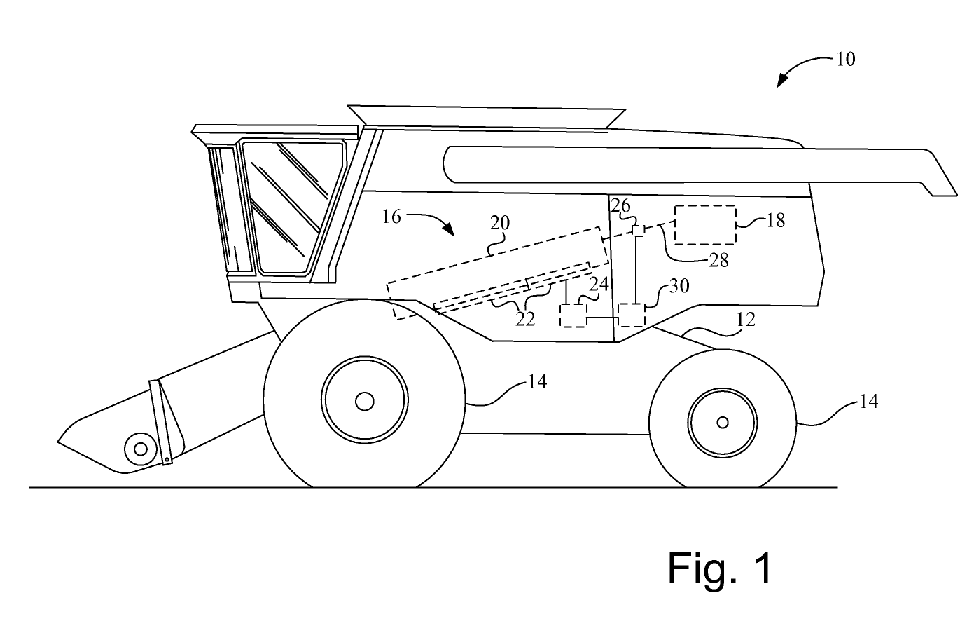

Referring now to the drawings, and more particularly to FIG. 1, there is shown a harvesting machine 10 having a chassis 12 supported by wheels 14. A grain threshing assembly 16 receives crop matter containing grain that is gathered by a head mechanism on harvester 10. Grain threshing assembly 16 includes a rotor 20 that is driven by engine 18. Rotor 20 is positioned proximate to concaves 22, which allow grain to fall through openings in concaves 22 that has been loosened from the crop matter by the rotating action of rotor 20. Concaves 22 are curved to correspond to the shape of rotor 20 and concaves 22 are positioned by an adjusting mechanism 24, also known as an actuator 24, to properly position concaves 22 relative to rotor 20. Grain threshing assembly 16 further includes a torque sensor 26, a shaft 28 and a controller 30.

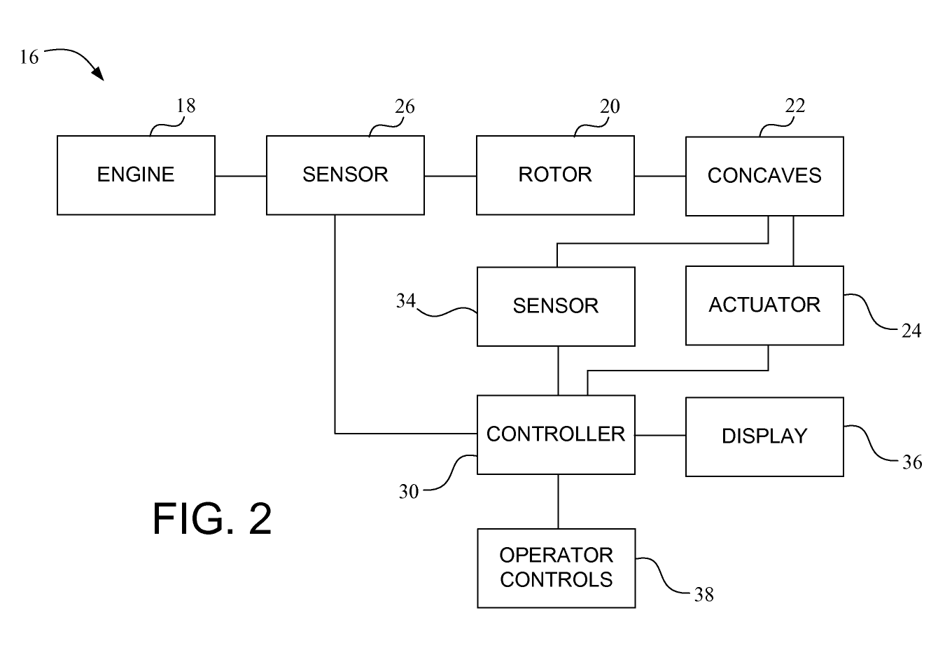

Now, additionally referring to FIG. 2, there is shown a schematical diagram that include elements of grain threshing assembly 16 including sensors 26 and 34, a display 36 and operator controls 38. As crop matter enters grain threshing assembly 16, rotor 20 is powered by engine 18 by way of shaft 28 to provide a rotational torque to rotor 20. For the ease of understanding the invention, the mechanism coupling engine 18 to rotor 20 is described as a shaft 28, the coupling that drives rotor 20 may be in another form, such as a hydraulic motor that is supplied a hydraulic fluid pressure from a pump connected to engine 18. A torque sensor 26 is connected either to shaft 28 or is associated with either rotor 20 or engine 18 to provide a signal to controller 30 that relates to the torque being used to drive rotor 20 as it threshes crop matter between rotor 20 and concaves 22. Torque sensor 26 may be of any form to provide a signal that is representative of the torque used to drive rotor 20. For example torque sensor 26 may be a strain gauge, a measurement of the torsional flex of shaft 28 or some other method of measuring torque. Torque sensor 26 also provides speed information on the speed at which rotor 20 is being driven. Controller 30 is tasked to adjust concaves 22 by way of actuator 24 based upon the torque and speed information provided from sensor 26. Actuator 24 may be in the form of a hydraulic actuator, an electrical actuator, a pneumatic actuator or even a combination of these forms in order to position concave 22 at a desired position relative to rotor 20 for the optimal threshing of grain. Sensor 34 provides positional information, of concaves 22 relative to rotor 20, to controller 30, also known as concave clearance. A display 36 provides a visual display of the concave clearance information as well as torque and speed of rotor 20 so that the operator can, by way of operator controls 28, provide adjusting information to controller 30 for the control of the positioning of concaves 20, and also allows the operator to adjust the engine and/or rotor speed.

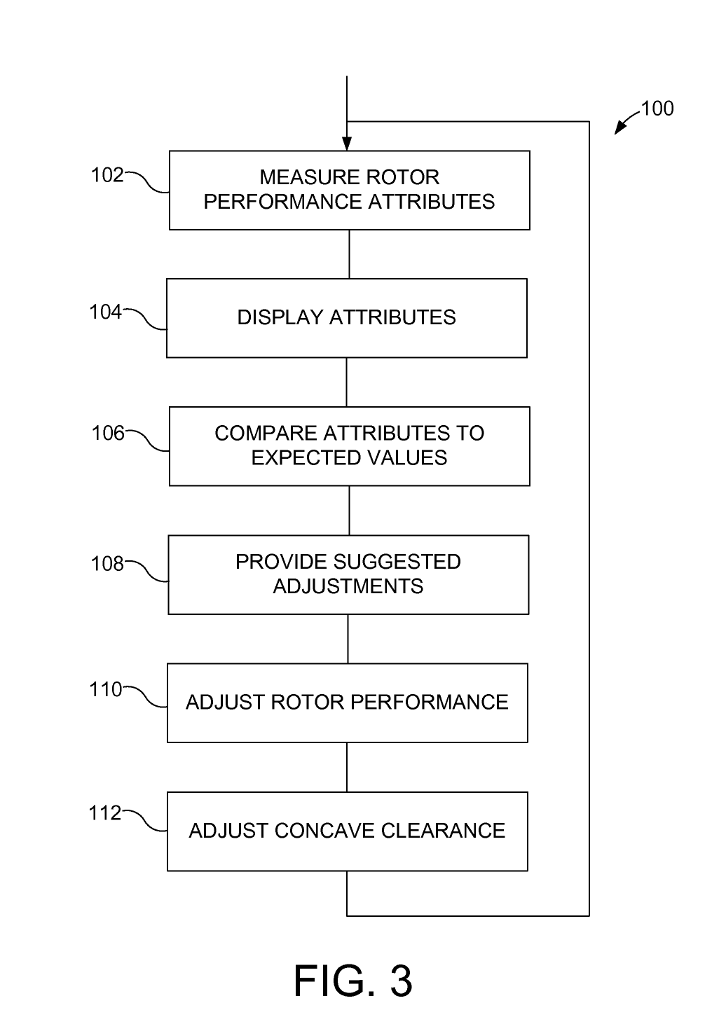

Now, additionally referring to FIG. 3, there is shown a flowchart that illustrates the steps involved in the present invention. Method 100 includes steps 102-112. At step 102 performance attributes of rotor 20 are measured, which may include the torque that is required to drive rotor 20 as well as the speed of rotor 20 and even other attributes such as vibrational characteristics. The attributes are displayed at step 104 on display 36 to provide an operator information relative to the performance of rotor 20. The attributes measured at step 102 are compared to expected and/or desired attributes at step 106 by controller 30. As a result of the comparison undertaken at step 106 suggested adjustments are visually illustrated on display 36, at step 108 to the operator, so that the operator may make an informed decision as to any adjustments in the commanded performance of rotor 20 that may be necessary. The performance of rotor 20 is adjusted at step 110, which may include changes of speed or available torque to rotor 20. Additionally, at step 112, the concave clearance may be adjusted by having actuator 24 reposition concaves 22 relative to rotor 20. This action of either decreasing or increasing the clearance between concaves 22 and rotor 20 alter the performance of harvester 10 as it gathers and separates grain.

Advantageously the invention measures torque supplied to rotor 20 as well as the speed by way of sensor 26, which is connected to a controller 30. Controller 30 may be assimilated within a controller used for other functions in combine 10, or may be a separate controller, as illustrated herein for the ease of understanding. The torque computed by controller 30 is displayed on display 36 in the cab in the form of a gauge that informs the operator how much power is being consumed by rotor 20. Display 36 may display power in horsepower or kilowatts and may also have a needle or indicator that points to a zone of efficient operation for easy reference while operating harvesting machine 10. For example, an optimal zone of performance on display 36 could be green in color. The operator would drive and operate harvester 10 to keep the indicator in the green, or the power in kilowatts within a expected power range for the conditions being encountered.

Controller 30 can also receive inputs from operator controls 38 to indicate to controller 30 the type of crop being harvested, such as corn, wheat or soybeans. Other sensors can also be coupled to controller 30 to measure the grain moisture and feed rate of the crop matter coming into harvester 10. Controller 30 can use specific threshing power coefficients determined during field testing and computational algorithms to compute the expected power consumption for the given grain type, moisture content of the grain and or crop matter, and feed rates of the crop matter. If the power being consumed by rotor 20 falls outside of an expected power range for these conditions, then display 36 would show the power being consumed and the indicator would be moved away from the green condition to indicate a sub-optimal performance. Display 36 offer suggestions at step 108 for concave clearance and rotor speed, which the operator can change while continuing to operate harvester 10. This advantageously precludes the need to stop and look behind the combine or check a new grain sample from the grain bin. Rather, the operator can change the settings and then immediately check the impact on rotor power for confirmation as to the correctness of the settings as compared to the experience validated during field testing.

Additionally, controller 30 may be enabled to automatically adjust the concave clearance in response to the consumed rotor power automatically. If the power demand increases in response to higher feed rates, concaves 22 can be opened slightly to permit the higher volume of material to pass through without taking excessive power to drive rotor 20. In light load conditions, the concave clearance is reduced to automatically maintain good threshing with the lighter crop material flow. In this way, threshing system can automatically adjust to varying crop yields as the machine travels across the field. This also allows the maintaining of high threshing efficiency as conditions vary, reducing power consumption and reducing grain losses.

The operator may, by way of operator controls 38, disable the automatic function to stop the automatic concave adjustment function. Additionally, the operator can key-in a range of automatic adjustments to enable system 16 to adjust but only to the specified degree relates to the range input by the operator. The present invention enables quick and accurate power monitoring of threshing rotor 20 while harvesting and verification that the concave clearance and the rotor speed settings conform to the given crop, moisture and feed rate conditions compared to what is determined for harvester 10 as optimal elements for performance for fuel consumption, grain loss and damage. This allows machine 10 to operate near optimal settings while reducing wear and tear on the threshing elements. This system can additionally learn from the adjustments undertaken manually to automatically make the required adjustments to maximize field performance.

Having described the preferred embodiment, it will become apparent that various modifications can be made without departing from the scope of the invention as defined in the accompanying claims.

1. A harvesting machine, comprising:
an engine; and
a grain threshing system driven by said engine, said grain threshing system including:
at least one rotating member receiving a torque from said engine;
at least one concave proximate to said at least one rotating member;
a torque measuring device coupled to one of said rotating member and said engine, said torque measuring device producing a signal related to said torque; and
an adjustment mechanism coupled to said at least one concave, said adjusting mechanism configured to position said at least one concave relative to said at least one rotating member dependent upon said signal.

2. The harvesting machine of claim 1, further comprising a controller receiving said signal, said controller controlling said adjustment mechanism dependent upon said signal.

3. The harvesting machine of claim 2, wherein said torque measuring device additionally includes information in said signal regarding a speed of rotation of said at least one rotating member.

4. The harvesting machine of claim 3, further comprising a display in communication with said controller, said display providing a visual indicating of at least one of said torque, said speed and said position of said at least one concave.

5. The harvesting machine of claim 4, further comprising an operator control in communication with said controller, said operator control configured to receive commands from an operator, said commands including a concave clearance setting that is processed by said controller and used to adjust said at least one concave to a position corresponding to said concave clearance.

6. The harvesting machine of claim 5, wherein said controller is configured to send suggested settings of said concave clearance and said speed of rotation of said at least one rotating member to said display.

7. The harvesting machine of claim 2, wherein said controller is configured to use an algorithm to control said adjusting mechanism, said algorithm using said signal and at least one of power coefficients, grain type, moisture content of the grain and feed rate of crop matter as inputs to control said adjusting mechanism.

8. A grain threshing system for a harvesting machine having an engine, the grain threshing system, comprising:
at least one rotating member receiving a torque from the engine;
at least one concave proximate to said at least one rotating member;
a torque measuring device coupled to one of said rotating member and the engine, said torque measuring device producing a signal related to said torque; and
an adjustment mechanism coupled to said at least one concave, said adjusting mechanism configured to position said at least one concave relative to said at least one rotating member dependent upon said signal.

9. The grain threshing system of claim 8, further comprising a controller receiving said signal, said controller controlling said adjustment mechanism dependent upon said signal.

10. The grain threshing system of claim 9, wherein said torque measuring device additionally includes information in said signal regarding a speed of rotation of said at least one rotating member.

11. The grain threshing system of claim 10, further comprising a display in communication with said controller, said display providing a visual indicating of at least one of said torque, said speed and said position of said at least one concave.

12. The grain threshing system of claim 11, further comprising an operator control in communication with said controller, said operator control configured to receive commands from an operator, said commands including a concave clearance setting that is processed by said controller and used to adjust said at least one concave to a position corresponding to said concave clearance.

13. The grain threshing system of claim 12, wherein said controller is configured to send suggested settings of said concave clearance and said speed of rotation of said at least one rotating member to said display.

14. The grain threshing system of claim 9, wherein said controller is configured to use an algorithm to control said adjusting mechanism, said algorithm using said signal and at least one of power coefficients, grain type, moisture content of the grain and feed rate of crop matter as inputs to control said adjusting mechanism.

15. A method of controlling a grain threshing system in a harvesting machine, the method comprising the steps of:
measuring a torque required to rotate a rotor in the grain threshing system; and
adjusting at least one concave dependant upon said torque, said concave being proximate to said rotor.

16. The method of claim 15, further comprising the step of adjusting a performance of said rotor dependant upon said torque.

17. The method of claim 15, wherein said adjusting step is carried out by a controller that receives a signal representative of said torque from a torque measuring device that carries out said measuring step.

18. The method of claim 15, further comprising the step of displaying said torque to an operator.

19. The method of claim 18, further comprising the step of providing suggested operating settings of said torque to the operator.

20. The method of claim 19, wherein said adjusting step is additionally dependent upon at least one of power coefficients, grain type, moisture content of the grain and feed rate of crop matter.
